(19) United States
(12) Patent Application Publication
(10) Pub. No.: US 2024/0411988 A1
(43) Pub. Date: Dec. 12, 2024

(54) DYNAMIC NATURAL LANGUAGE PROCESSING SYSTEM FOR IMPROVED CONTEXTUAL UNDERSTANDING AND INTERACTIVE RESPONSE

(71) Applicant: Kamazooie Development Corporation, Maple (CA)

(72) Inventors: Brian Douglas Ritchie, Maple (CA); Chengyou Wang, York (CA); Kaiyang Li, Markham (CA); Gabriel Atilio Carrillo Seijas, Toronto, Ontario (CA); Behrooz Darabiha, Oakville (CA)

(21) Appl. No.: 18/614,235

(22) Filed: Mar. 22, 2024

Related U.S. Application Data
(60) Provisional application No. 63/507,568, filed on Jun. 12, 2023.

(51) Int. Cl. G06F 40/226; G06F 40/232

(52) U.S. Cl. CPC G06F 40/226; G06F 40/232

(57) ABSTRACT

Systems and methods for contextual inference and response generation in natural language processing are disclosed. A data structure containing Knowledge Records, terms, and Relationship Types is accessed to facilitate interaction and inference. Knowledge states and uses relationship properties are employed for inference, classifying terms to generate responses. Logic and inference mechanism link Knowledge Records and Terms for response generation. Responses are tailored based on Criteria-Value Rating Pairs and user Traits, with the system adapting through learnings from user interactions and external data. The method includes storing interaction graphs and features modules for natural language understanding, interaction, response generation, and user engagement, executed on a processing unit. The system dynamically updates its Knowledgebase and refines response mechanisms, offering personalized and contextually relevant interactions in natural language. Additionally, the system provides structured contextual and criteria-value data to third-party systems such as Large Language Models (LLM) s via APIs, enhancing contextual understanding and interaction.

### CROSS-REFERENCE TO RELATED APPLICATIONS

This application claims the benefit of U.S. Provisional Application No. 63/507,568, filed on Jun. 12, 2023, which is hereby incorporated by reference in its entirety.

### FIELD OF THE INVENTION

The field of the invention is natural language processing and, in particular, a method and a system for dynamic contextual inference and interactive response generation.

### BACKGROUND OF THE INVENTION

The following description includes information that may be useful in understanding the present invention. It is not an admission that any of the information provided herein is prior art or relevant to the presently claimed invention, or that any publication specifically or implicitly referenced is prior art.

Artificial Intelligence (AI) technology and applications have flourished in recent years, with Machine Learning (ML) as a predominant technology. Knowledge base approaches, including open-source methods like Resource Description Framework (RDF) and Web Ontology Language (OWL), are also advancing. However, a challenge remains with these approaches to arrive at a comprehensive human-like conversational system. These systems often struggle to process information and explore contextual inferences in user input beyond the literal words and context provided by the user.

Furthermore, typically, AI platforms that deliver conversational service, generative or otherwise, lack the ability to interact with information personalized for a user's values and interests. They also often fail to respond to the user with truth, empathy, ethics, and the most relevant responses, or two-way dialog issue validations, based on contextual inference.

Thus, there is still a need for a system that allows for advanced personalization and empathetic engagement and to mitigate some of the limitations in current AI conversational systems in understanding and responding to the nuanced needs and desires of users.

Moreover, there is a need for alternatives to current conversational AI systems.

### BRIEF DESCRIPTION OF DRAWINGS

Various objects, features, aspects, and advantages of the inventive subject matter will become more apparent from the following detailed description of preferred embodiments, along with the accompanying drawing figures in which like numerals represent like components.

FIG. 1 is a block diagram of a system architecture for a dynamic natural language processing system for improved contextual understanding and interactive response, in accordance with an example of the present specification.

FIG. 2 is a schematic implementation of the dynamic natural language processing system of FIG. 1.

FIG. 3 is a diagram depicting the data structure and processing flow of the dynamic natural language processing system of FIG. 1.

FIG. 4 is a flow diagram showing the steps for processing user inputs, generating responses, and acquiring knowledge in the natural language processing system of FIG. 1.

FIG. 5 is a flow diagram showing the process for accessing and handling data within a Knowledgebase of the system of FIG. 1.

FIG. 6 is a flow diagram showing how the system of FIG. 1 analyzes user information and selects or generates responses.

FIG. 7 is a flow diagram showing the method for managing and updating knowledge states based on user interactions, performed in the system of FIG. 1.

FIG. 8 is a flow diagram showing how the system of FIG. 1 applies relationship properties to improve inference and response accuracy.

FIG. 9 is a flow diagram showing the classification of terms within the system of FIG. 1 to enhance response generation.

FIG. 10 is a flow diagram showing how responses are tailored based on criteria-value ratings and user personality traits, as performed in the system of FIG. 1.

FIG. 11 is a block diagram of a system for dynamic natural language processing system in accordance with an example.

### DETAILED DESCRIPTION OF THE INVENTION

This detailed description provides an explanation of the embodiments of the present specification. The present specification encompasses a variety of systems, methods, and non-transitory computer-readable media.

According to one example of the present specification, a method for contextual inference and response generation in natural language processing is disclosed. The method involves accessing a data structure containing Knowledge Records, terms, and Relationship Types to facilitate user interaction. The method employs knowledge states and invokes relationship properties for making inferences. The method also classifies terms using these Knowledge Records to generate responses. The approach involves associating logic and inference by linking Knowledge Records to terms and to other Knowledge Records. The method generates or selects responses based on Criteria-Value Rating Pairs and user traits, integrating learnings from user interactions and external data into the system. This includes adjusting algorithmic parameters and building models. The method also selects responses based on user location, stores interaction graphs for further analysis, and engages with users and communities to acquire additional knowledge. This method is executed by a computer system's processing unit.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of features used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed considering the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

According to one example of the present specification, the method can be implemented in a server or computer system equipped with processors, memory, and storage configured to execute natural language processing tasks. The server can be a general-purpose computer or a specialized system, sometimes called an accelerated system, selected to run machine learning models, including neural networks, decision trees, and support vector machines, for processing and analyzing linguistic data. In operation, the system performs sequential data processing steps: collecting raw data, cleaning it to remove inaccuracies, normalizing for consistency, and then analyzing it. Machine learning algorithms in the system analyze the data to detect patterns, enabling the generation of contextually relevant responses based on the insights gained from the models. For machine learning model training, the system uses extensive datasets to iteratively refine the models' parameters. This refinement process enhances the system's accuracy and performance, using a mix of learning techniques such as supervised learning for specific tasks and unsupervised learning for pattern discovery.

According to one example of the present specification, the user interface of the system allows users to provide input, modify settings, and view the system's outputs. The interface is accessible through various platforms, including web-based, mobile, and desktop applications, ensuring user-friendly interaction with the system's capabilities.

According to some examples, the system is implemented on a cloud-based platform, offering scalable computing power and storage to handle the demands of extensive natural language processing tasks. Through networking, the system accesses distributed data sources, integrates with other platforms, and delivers services to users remotely, ensuring performance across different locations.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The methods and systems described in this specification improves upon the technology in U.S. Pat. No. 9,104,780, which is fully incorporated by reference. According to examples of the present specification, the system enhances contextual inference by comparing information with an existing knowledge base and uses personalized criteria-value ratings and automated interactions to support emotional and empathetic natural language conversations in text or speech. The System also incorporates Large Language Model (LLM) applications to improve Natural Language Understanding (NLU) and response generation.

According to examples of the present specification, the system design includes multiple knowledge states for conversational intelligence, enabling issue validation (true, false) with the user. It features logic and inference driven by Relationship Type properties, with enhancements allowing associations to other Relationship Types, exemplified by inverse relationships like “has child” and “has parent.” Term categorization is leveraged for natural language generation, using Knowledge Records to classify terms such as “hello” as a “greeting.” The system enhances logic and inference through Knowledge Record to Term and Knowledge Record to Knowledge Record associations, enabling nuanced user interactions and validation.

Responses are personalized using Extended Data and Criteria-Value Rating Pairs, tailored to user personality traits. The system's self-learning capabilities draw from user conversations and external data, enhancing the knowledge base. Natural language generation or response selection is influenced by user location and personality traits, ensuring relevance and personalization. Long-term storage of conversation graphs aids in recalling user interactions and contextual information.

Unlike conventional search engine technology, natural language systems according to examples of the present specification prioritize context-aware dialogue and personalized response generation over simple keyword-based information retrieval. It leverages machine learning to dynamically interpret and respond to user input, refining its responses through ongoing interaction and learning. Unlike search engines, this system is able to integrates with third-party systems such as LLMs via APIs, providing structured, context-rich data, not just raw information, ensuring nuanced, user-specific interactions.

In the context of this specification, “response” means the output produced by a system in reaction to user input or environmental stimuli. It encompasses a wide range of formats including, but not limited to, textual content, image diffusion outputs (such as generated graphics or photos), video clips, audio messages, and interactive elements. The nature of the response is determined by the system's understanding of the input context, user preferences, and the intended communication goals. While search engine replies typically consist of a list of links or documents ranked based on their relevance to the query keywords, a response in NLP systems is tailored to the user's immediate conversational context, emotional state, and specific preferences. It goes beyond fetching and displaying existing information to generating new, coherent, and contextually appropriate content or actions, such as text, images, videos, or interactive elements, that are directly aligned with the user's intent and interaction history.

Interaction with users during conversational engagements helps to infer new Knowledge Records and gather input on criteria-value ratings, enhancing either automated or Human-in-the-Loop knowledge learning process. Proactive community engagement further refines Knowledge Records and criteria-value ratings. The use of a Large Language Model (LLM) ensures consistent response generation with the user's language style and summarization of long inputs, while maintaining key issues. Advanced inference and real-time intelligent search are employed, alongside LLM summarization and prompt engineering, to provide up-to-date information from external sources, ensuring comprehensive and contextually appropriate responses.

Table 1 compares elements from U.S. Pat. No. 9,104,780 with those in the present specification, along with their descriptions. The “Metadata Database” has become the “Knowledgebase,” now storing contextual information. The “Graph Data Structure” is updated to the “Conversation Graph,” indicating an approach to mapping dialogues. “Entity Data Values” are now “Terms,” representing specific concepts, and “Relationship Data Values” have transitioned to “Relationship Types,” defining how terms connect to form knowledge. This terminology reflects a more contextual approach in natural language processing system design.

TABLE 1
Terminology Comparison

| U.S. Pat. No. | Present | |
|---|---|---|
| 9,104,780 | Specification | Description |
| Metadata Database | Knowledgebase | Storage of real-world contextual |
| | | information and contextual |
| | | information particular to |
| | | various industries, sectors, |
| | | customer organizations and the |
| | | like. Also, containing various |
| | | other meta-data that informs |
| | | the overall system in its |
| | | operation such as various entity |
| | | property, relationship, and |
| | | other ontological and |
| | | grammatical information. |
| Graph Data | Conversation | A sub-graph of the |
| Structure | Graph | Knowledgebase formed during |
| | | the real-time conversation with |
| | | the user, maintained for |
| | | contextualization and |
| | | contextual reference (i.e. |
| | | ‘daughter’, later becomes, |
| | | ‘Kate’, later becomes ‘she’ |
| | | during the conversation) |
| Entity Data | Terms | A single or multi-word term that |
| Values | | defines a known concept like |
| | | “air conditioner” or “west coast |
| | | lifestyle” |
| Relationship | Relationship | The joining entities (i.e. “can |
| Data Values | Types | be”) that allow two Terms to be |
| | | joined to create a piece of |
| | | ‘knowledge’ such as “person |
| | | can be hungry” or “person can |
| | | possess house” |

According to some examples of the present specification, the system incorporates enhancements, as discussed over the next few paragraphs.

For example, the system includes the adoption of multiple states of knowledge to support conversational intelligence. This allows for the validation of information with the user, determining whether something is an issue or not, and establishing its truthfulness and maintaining that context or state in the Conversation Graph.

The system also includes enhancements in logic and inference, which are driven by Relationship Type Properties. These properties are enriched by optional associations to other Relationship Types. For example, the “has child” relationship has an inverse property to “has parent,” where “has inverse” is a Relationship Type property. This allows “has parent” to be an optional Relationship Type to “has child” that can be associated through the “has inverse” Relationship Type property.

Furthermore, logic encapsulation and enhanced inference, along with improved user interaction and validation, are enabled by the association of Knowledge Records to Terms, as exemplified by linking the concept “house” with the condition “burned” in a Knowledge Record, which collectively form the Term “house fire”. This association facilitates a more nuanced inference understanding and processing of information within the system. This is also facilitated by the association between Knowledge Records. An example of this is the association “person can be struck by automobile”, enabling empathetic natural language generation or response selection for a particular context for which there may be no direct ‘solution’ but the Knowledge Record association may provide inference to other Knowledge Records that may be present in the context and needs to be validated by the user. In this case, additional data relating to the inferred (associated) Knowledge Record is used to validate the inferred context such as “Has there been an injury?” in the case of “person can be struck by automobile” Criteria-Value Rating Pair.

Moreover, the natural language generation or response selection can be enhanced through conversational prioritization based on personality traits. This approach enables the system to tailor its responses and tone more effectively to align with the varying personalities of users, ensuring that the communication is appropriate and resonant for each individual.

The system also features self-learning capabilities, drawing from user conversations and external data sources. It “reads” and applies Natural Language Understanding (NLU) techniques to assimilate and store new triples (discussed in more detail below) in the system's Knowledgebase, continuously enriching its repository of information and enhancing its response accuracy and relevance.

The system also includes a feature for natural language generation or response selection based on a user's location, using location information from the user's access device. This functionality allows the system to generate or select responses that are geographically relevant and personalized to the user's current situation or environment.

Furthermore, the system incorporates the long-term storage of Conversation Graphs, which serves to preserve the history of interactions with users. This functionality enables the system to maintain a memory of past communications, enhancing its ability to provide contextually rich and personalized responses over time.

As well, the system facilitates interaction with users during normal conversational engagements to identify new Knowledge Records inferred within the conversation. Additionally, it engages users to gather input on related criteria-value ratings, supporting Human-in-the-Loop knowledge learning from the user community. This process helps to continually refine and expand the system's Knowledgebase, ensuring that it remains dynamic and responsive to user interactions.

The system may also engage in proactive, outbound interaction with communities of users to identify new Knowledge Records and gather related criteria-value ratings through either automated or human-assisted means. Again, this approach is part of the Human-in-the-Loop knowledge learning process, aiming to actively incorporate user feedback and insights into the system's Knowledgebase, thus enhancing its learning and adaptability.

Additionally, the system integrates a Large Language Model (LLM). This model is employed to generate responses that align with the distinct linguistic style of a specific user, leveraging historical interactions or previously submitted writings as input. This approach enables the LLM to tailor its outputs to mirror the user's unique communication patterns, thereby enhancing the personalization of the system's responses. The may system further employs a LLM to condense extensive inputs from the user, ensuring the preservation of core elements and issues articulated within the user's submission.

The system leverages inference mechanisms and employs a criteria-value rating approach to ascertain the user's primary concern or query. Subsequently, it utilizes real-time intelligent search capabilities, augmented by Large Language Model (LLM) based summarization and prompt engineering techniques, to provide up-to-date information. This information is sourced from external data repositories accessible via the internet or intranet, which are not necessarily contained within the system's internal Knowledgebase.

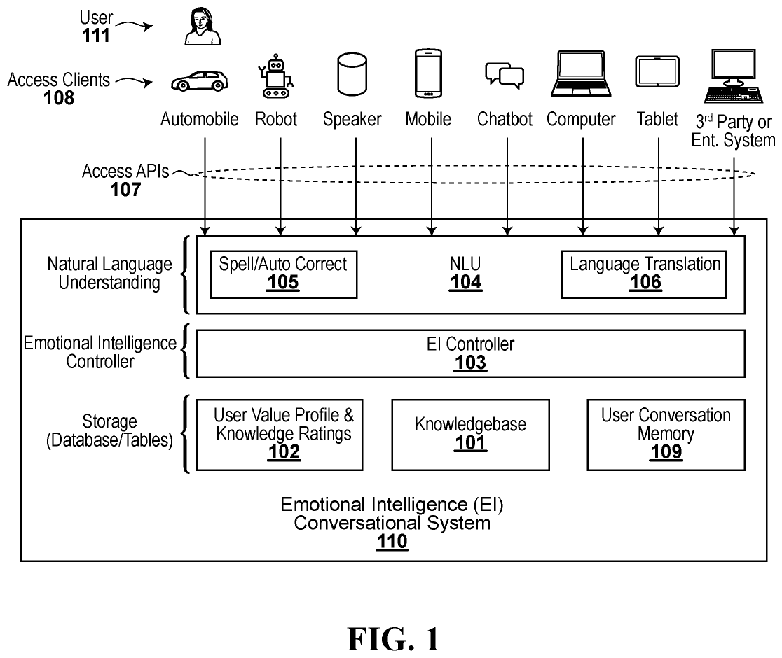

With reference to FIG. 1, an emotional, conversational intelligence system 110, according to an embodiment of the present specification, provides user electronic devices 111 with an emotionally intelligent conversational interface suitable for both enterprise and consumer applications. The Application Programming Interface (API) layer 107, permits multi-channel client access 108, supporting a diverse array of access devices such as automotive infotainment centers, smart speakers, and mobile devices. The API layer 107 enables the system 110 to function autonomously or as a conversational or contextual and value-rating information gateway to other enterprise or third-party systems.

To facilitate integration with third-party systems, including large language models (LLMs), the system is designed to provide contextual and ontological information, for example, as by focusing on Criteria-Value Rating Pair information. This approach fosters more human-like intelligence and interaction within these external systems. Integration with third-party systems refers to the ability of the system 110 to construct and share knowledge records (KRs) that are enriched with Criteria-Value Rating Pair Values. When interfacing with third-party systems like LLMs, the system can sequentially provide these enriched data points. By offering a structured flow of information, including KRs and their associated value pairs, third-party systems can access a stream of curated and contextually relevant data. This structured information allows these systems to perform generate responses that are not only factually accurate but also aligned with the nuanced needs and values of the end users. Moreover, by modularizing this workflow and offering it as an API interface, the system permits integration and real-time data provision to third-party applications. This modularity allows external systems to query and receive targeted information, aiding in their contextual analysis and decision-making processes. In doing so, the system 110 acts as an operating layer, supplying the necessary data and insights for third-party bots or LLMs to conduct detailed contextual analysis and generate informed responses, thereby enhancing the overall interaction quality and intelligence of these external systems.

Returning to FIG. 1, according to some examples of the present specification, input from a user is interpreted through the natural language understanding (NLU) layer 104, which includes functionalities for spell-checking and auto-correction or recommendation support 105, alongside input/output language translation 106. This architecture ensures that the system 110 comprehends user inputs across different languages, facilitating a nuanced understanding of user inquiries.

Still with reference to the exemplary system 110 of FIG. 1, the NLU layer 104 is designed to enhance the ability of the system 110 to process and interpret user inputs with high accuracy and context sensitivity. An additional feature of the NLU layer 104 is the integration of spelling and grammar correction capabilities through the spell/auto correct module 105. This functionality improves the ability of the system 110 to match user inputs with the existing language information within the Knowledgebase 101, by correcting any spelling or grammatical errors in the user's input, thereby ensuring more accurate and meaningful interactions. Within the NLU layer 104, advanced natural language understanding capabilities are employed to decode translated incoming utterances into smaller, discrete blocks of knowledge, often referred to as “triples”. This process involves breaking down complex statements into simpler, knowledge-like elements that encapsulate the fundamental relationships between subjects, objects, and their attributes or actions. For instance, an input statement such as “my father has a red car” would be decomposed into a series of triples: “I have father; father has car; car is red”. This decomposition into triples facilitates a more structured and recognizable form of information for further processing by the emotional intelligence (EI) controller 103, enabling it to understand and respond to user inputs more effectively.

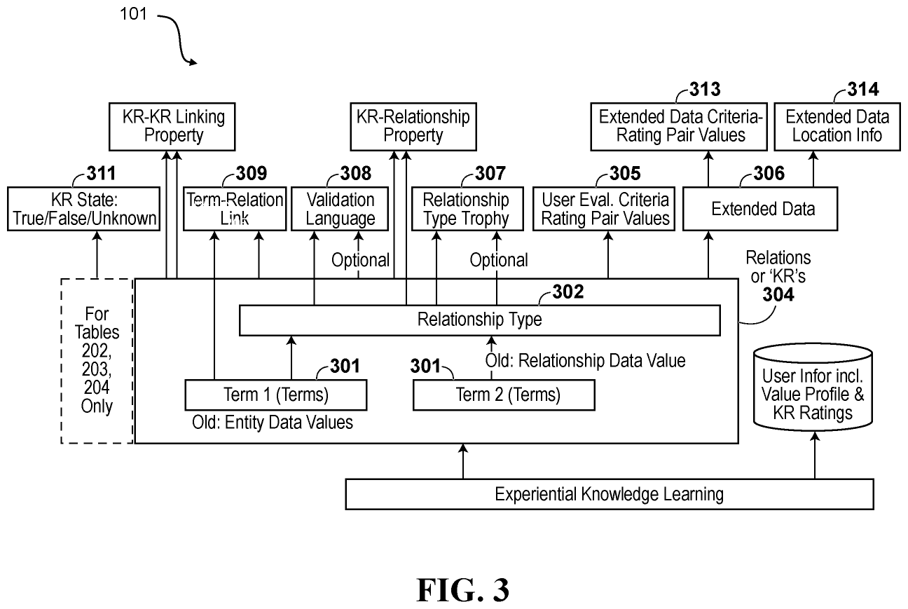

In FIG. 1, the Knowledgebase 101, alongside the Criteria-Value Rating Pair data, is an aspect of the system 110. According to this example, the Knowledgebase 101 is a structured network comprising nodes, referred to as Terms 301 (shown in FIG. 3), and connections, known as Relationship Types 302 (again, shown in FIG. 3), which together create Knowledge Records (KRs) 304 (as in FIG. 3) or informational triples. These KRs serve as the fundamental units of knowledge within the system 110 (shown in FIG. 1). Knowledge Records (or KRs) can be categorized based on their accessibility: ‘Public’ KRs are available to all organizations and their users within the system; ‘Private’ KRs are exclusive to a specific enterprise or organization, intended solely for conversations involving that organization's users; and ‘Protected’ KRs, which, while proprietary, can be shared with other organizations affiliated with the host organization. This classification allows for a flexible use of KRs, enabling conversations to be supported by a blend of Public, Protected, and Private KRs, according to the specific needs and affiliations of the organization in question. A KR 304 is constructed by linking one Term 301 through a Relationship Type 302 to another Term 301, forming the structural basis of the knowledge framework of the system 110. The establishment of metadata, such as Relationship Types, is managed to ensure precise meaning and avoid ambiguity in natural language processing. To bridge the gap between user utterances and the structured data within the NLU layer 104 and the EI Controller 103, the system 110 employs natural language optimization techniques. These include handling synonyms both between Terms 301 and in the context of Relationship Types. Such synonym handling ensures alignment between the user's language and the internal processing of the system 110, facilitating a balance between input language flexibility and the clarity required at the EI Controller 103 and Knowledgebase 101 layers. Furthermore, a specific technique known as Relationship Type Synonyms is used to align common language inputs with distinct and discrete Relationship Types between the EI Controller 103 and the Knowledgebase 101. This method ensures that even when users express themselves in varied ways, the system can accurately map these inputs to specific, predefined Relationship Types within its knowledge framework, enhancing the accuracy and relevance of the system's responses and interactions.

Furthermore, the NLU layer 104 leverages the information contained within the Knowledgebase 101 to enhance its processing capabilities. This includes, but is not limited to, identifying the parts of speech (such as nouns, verbs, etc.) for different Terms 301, recognizing terms that are members of specific categories (for example, days of the week or terms that indicate categorization such as ‘car is a type of automobile’), and associating specific KRs 304 with particular terms. For example, a KR 304 could be linked to the term “job loss” in the context of the statement “I lost my job”. This detailed information provided by the Knowledgebase 101 supports the NLU layer 104 in optimizing the natural language decoding of inputs, thereby enhancing the pre-processing efficiency for outputs directed to the EI Controller 103.

Advantageously, these processing techniques and the rich informational support from the Knowledgebase 101 enable the NLU layer 104 to interpret user inputs with accuracy and depth, assisting in the development and generation of meaningful and contextually aware responses by the system 110.

According to one example of the present specification, Personality Criteria-Rating Pair Values offer a nuanced understanding of knowledge from a user-centric perspective, thus enabling the system 110 to assess the human significance or impact of various situations and contexts with what might be termed an “emotional understanding.” This is achieved through a two-pronged approach. Firstly, each user is assigned numeric ratings or preferences for a range of ratable Criteria independent of specific knowledge pieces. These Criteria could include aspects such as “taste,” “health,” “companionship,” and “brand,” among others, allowing the system to quantify and incorporate individual preferences or aversions broadly.

Secondly, the system assigns a set of Criteria-Value Rating Pairs to each Knowledge Record 304 for every user. For example, a Knowledge Record 304 like “person—can consume-hamburger” would have an associated personalized preference rating, reflecting the user's subjective valuation of this piece of knowledge against various Criteria. This dual-dimensional rating system enables the system to personalize interactions with the Knowledgebase, tailoring its responses to fit the unique emotional and subjective context of each user.

By identifying problems and solutions through these personalized ratings-such as recognizing “hunger” as a problem with a negative rating and “eating a hamburger” as a positive, offsetting solution—the system 110 can prioritize or personalize solutions for each user. The personalized ratings are stored in a dedicated User Info area within the system 110, ensuring that the responses generated by the system 110 are not only informed by an understanding of the user's preferences but also by an emotional intelligence that recognizes and adapts to their needs and feelings. This approach enhances the capacity of the system 110 for meaningful, user-specific engagement, elevating its interactions beyond mere data processing to more empathetic communication.

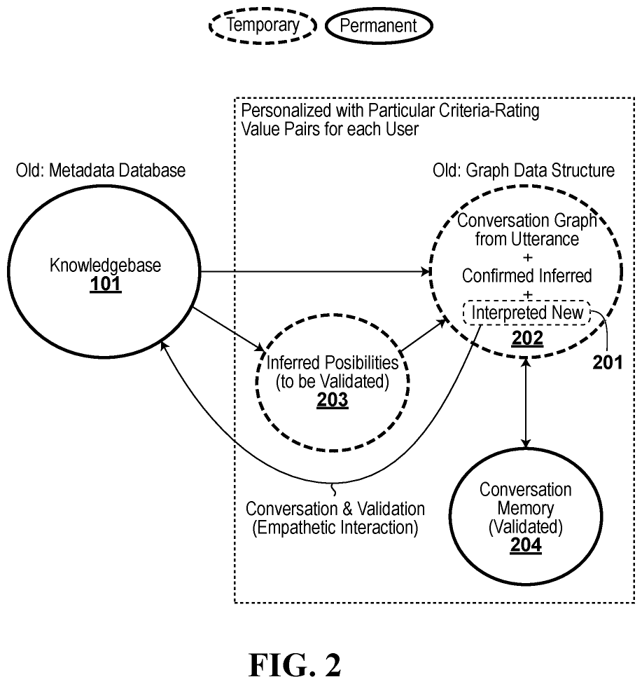

System 110, according to examples of the present specification, manages various knowledge states to support its conversational intelligence, using both temporary and long-term storage. As shown in FIG. 2, temporary storage, including database tables and server memory arrays, holds transient data like the Conversational Graph 202 and Inferred Possibilities 203. Long-term storage medium 204 is used for documenting user conversation states, enabling the system to recall and continue interactions seamlessly.

In one implementation, the NLU layer 104 outputs “Interpreted New” 201 triples that, if unrecognized by the EI Controller 103 as existing within the Knowledgebase 101, are flagged for addition, introducing a self-learning aspect to the system. This allows the system 110 to expand its Knowledgebase through user interactions. Additionally, these “Interpreted New” 201 triples or KR candidates become confirmed and added to the Knowledgebase 101 after Human-in-the-Loop validation, or once they reach a predetermined occurrence threshold. This process, driven by user interaction, enhances the system's knowledge dynamically, akin to the concept of a crawling bot, but focused on learning directly from conversational contexts.

With reference to FIG. 1, the Enhanced Emotional Intelligence Controller, EI Controller 103, plays a role in the exemplary system 110 by processing the output from the NLU layer 104. This output includes decoded natural language inputs from users, which the EI Controller 103 evaluates to discern the underlying context and any potential inferences. Using a combination of advanced inference techniques, controller logic, and data from the Knowledgebase 101, along with integrating user-specific Criteria-Value Rating Pairs 305 and Criteria-Value profiles, the EI Controller 103 facilitates interactions that mimic human-like conversational dynamics. This includes engaging in dialogue that may require the clarification of indirect inferences or nuanced implications suggested by the user's input in combination with the enhanced inference logic conveyed by Knowledge Record to Term, or Knowledge Record to Knowledge Record associations embodied in this specification. Thus the EI Controller 103 has the capability to identify direct issues or “problems” expressed in user utterances as in U.S. Pat. No. 9,104,780. The system 110, as per the present specification can also recognize and interpret potential inferences that may not be explicitly stated. This ability enhances the responsiveness and adaptability of the system 110, allowing for a more intuitive and context-aware interaction with the user, effectively bridging the gap between mere data processing and genuinely empathetic communication.

In one implementation of the system 110, the process of incorporating “Interpreted New” triples as Knowledge Records 304 (KR) into the Knowledgebase 101 is complemented by an interactive self-learning mechanism. This mechanism engages users in conversations specifically designed to refine the understanding of their preferences by the system 110. During these interactions, users are prompted to evaluate or assign ratings to various Criteria-Value pairs. These personalized ratings are then updated in the user's Value Profile and KR Ratings area 310 of the system 110. Advantageously, this interactive approach not only aids in the accurate addition of new knowledge to the Knowledgebase 110 but also ensures that the responses by the system 110 as well as recommendations are tailored to the evolving preferences and values of the user. Through this method, the system 110 dynamically enhances its user profiles, thereby improving its conversational relevance and personalized engagement over time.

According to one example of the present specification, the Conversation KR State in the system 110 supports conversational flow and memory by managing two parameters for Knowledge Records (KR) 304. The first parameter tracks whether a KR 304 has been validated with the user, indicated as “Validated True or False.” This guides the conversation logic, identifying KRs 304 that need to be discussed and confirmed with the user. For example, if the system infers “house fire can cause personal injury” from a user statement, this KR 304 is tagged in a temporary storage with “Validated” set to False, requiring user validation along with other so inferred KRs. To validate, the EI Controller 103 prioritizes KRs 304 based on Criteria-Value Rating Pairs and generates validation questions in priority order providing a more human-like concern for contextual situations. Depending on the user's response-confirmation, denial, or uncertainty-two states are recorded: one indicating the KR has been “Validated True,” and the other reflecting the user's specific response (True, False, or Unknown). After validation, the KR 304 is moved to the Conversation Graph. KR State can be confined to specific temporary storage areas, separate from the Knowledgebase, which holds KRs abstractly, without user-specific context. This approach ensures that foundational knowledge remains neutral while enabling personalized conversation dynamics and learning through user engagement.

In examples of the system 110 according to the present specification, enhanced conversation logic and inference mechanisms can be significantly influenced by the categorization of Terms 301 through Knowledge Records (KR) 304. When users introduce specific Terms 301 into the conversation, these Terms 301 can trigger predefined logic within the EI Controller 103. For instance, a user saying “Good morning” triggers a recognition process in the Knowledgebase 101, identifying it as a greeting based on a KR 304 that categorizes “Good morning” as a type of “greeting,” utilizing defined Terms 301 and Relationship Types. This categorization enables the Knowledgebase 101 and relevant KRs 304 to serve as cues for the EI Controller 103, prompting it to engage specific response logic, such as generating natural language responses to greetings. This example illustrates how key Terms 304 in conversations can control Natural Language Generation (NLG), enabling the system to interact in a contextually appropriate manner. Further applications of this logic extend to managing conversations involving inappropriate or politically incorrect language. Terms 301 classified under categories like “offensive” or “politically incorrect” through KRs 304 trigger the EI Controller to take specific actions. These include identifying the occurrence of such Terms 301 in conversation inputs and formulating appropriate NLG responses. Additionally, the system may optionally implement special logic, such as Greeting Management to produce suitable greetings or Gratitude Management to respond to expressions of thanks, enhancing the conversational experience based on the context and content of user inputs. This approach involves the definition of special term classes within the Knowledgebase 101, the creation of KRs 304 to categorize Terms 301 accordingly, and the development of EI Controller 103 code to detect these Terms 304 and generate responses. Such a framework allows the system 110 to adapt its interactions dynamically, ensuring relevance and appropriateness in its conversational engagements.

To enhance the encapsulation of knowledge and logic within the Knowledgebase 101 and bolster inference capabilities of the system 110, a novel association mechanism between Knowledge Records (KR) 304 and Terms 301 is utilized. This mechanism, known as the KR to Term link 307, allows for the association of specific KRs, such as “house—can be—burned,” with more complex Terms, like “house fire,” through a “has Super-Term” link type. This approach not only simplifies the representation of complex relationships within the Knowledgebase but also significantly amplifies the system's inferential logic capabilities. For instance, upon receiving a user input like “my house burned down,” this linkage system enables the identification of the direct issue encapsulated by the KR 304 “house can be burned.” More importantly, through the enhanced inferential logic provided by the KR to Term link 307, it further allows for the determination that “house fire” is a related Term 301, thus uncovering related negatively rated issues such as “house fire can cause personal injury” and “house fire can cause death.” These inferred possibilities are subsequently stored in the “Inferred Possibilities” table 203 within the EI Controller 103, earmarked for user validation as part of the ongoing conversation as previously discussed. The net value derived from the Criteria-Value Rating Pairs plays a role in guiding the conversational algorithm within the EI Controller 103. It prioritizes the validation and exploration of possibilities based on their emotional impact, starting with those having the highest negative ratings and progressively addressing less impactful issues. This ensures a responsive and empathetically prioritized engagement with the user, based on the logical and emotional weight of the inferred possibilities. The utility of the KR-Term link 307 extends beyond the mere embedding of knowledge and logic; it also facilitates the exploration of other relationships within Knowledgebase 101 between Terms 301 and KRs 304. Examples include linking the KR “person can be depressed” with the Term “suicide” through a “has risk” type link, or associating the KR “person can win lottery” with the Term “wealthy” via a “has possible attribute” link. This extended functionality of the KR-Term linkage enriches System 110's ability to navigate and leverage the Knowledgebase 101 effectively, enhancing the inferential processes of the system 110 and the relevance and depth of its conversational engagements.

System 110 enhances its logic encapsulation and inference capabilities through sophisticated associations between Knowledge Records (KR) and Relationship Types, as well as direct KR-KR linking. The association of a KR to Relationship Types enables System 110 to specify detailed relationships, such as distinguishing between “person-can have son-person” and “person-can have daughter-person” from a general “person-can have-family” relationship. This nuanced approach to defining relationships within Knowledgebase 101 allows for a richer, more precise understanding of terms and their connections, facilitating advanced logic encapsulation and inference.

Further enhancing the system's inferential framework, KR-KR linking serves as a useful mechanism for driving understanding and enhanced inference, influencing how conversational interactions are conducted for empathetic responses or validation of potential contextual situations derived from the Knowledgebase. By establishing links characterized by properties such as ‘has risk,’ ‘has option,’ ‘has requirement,’ and ‘can infer,’ the system 110 constructs an interconnected knowledge graph. This structure enables the system to navigate complex knowledge landscapes, drawing inferences that inform conversational logic and user interactions. Complementing these mechanisms, the introduction of a “Property” feature to Relationship Types 302 by the system 110 adds an additional layer of inference capability. This feature supports advanced logic such as inheritance, exemplified by properties like “is a member of” or “can be contained in.” Such properties enable the EI Controller 103 to deduce broader implications from specific user utterances, enhancing the system's ability to make contextually relevant inferences. For instance, from an utterance indicating a house fire, the system might infer potential injury or damage to contents or inhabitants based on the relational properties defined. Together, these strategies for linking KRs to Relationship Types and other KRs, augmented by the introduction of relationship properties, enhance the ability of the system 110 to understand and engage with users in a more contextually aware and emotionally resonant manner. By leveraging this knowledge structure, the system 110 achieves a higher level of conversational intelligence, capable of generating responses that are both contextually relevant and empathetically aligned with the user's needs and situations.

In System 110, the logic and inference capabilities can be further advanced through the use of Relationship Type Properties, which, when combined with optional associations to other Relationship Types, enable a more complex inference mechanism. This approach allows for the dynamic association of one Relationship Type to another, leveraging a second “Optional” KR link to the Property 312 that defines the association with a second KR. This method facilitates enhanced inferential logic that can extend the understanding of user utterances and the relationships between concepts within Knowledgebase 101. An illustrative example of this is when a user says, “I was in my car.” Initial NLU processing might identify triples such as “Person can possess car” and “Person can be in car,” with “can be in” recognized as a valid Relationship Type. Utilizing the optional association method, it is possible to define that the Relationship Type “can be in” possesses a Property “has inverse,” which is linked to another Relationship Type “can contain.” This linkage allows for the inference of an additional relationship: “car can contain person,” where “can contain” becomes a valid Relationship Type associated with “can be in” through the Relationship Type Property “has inverse.” The “has inverse” association is just one example among many possible associations between Relationship Types that can drive additional inference logic, including “has opposite” and “has alternative.” These associations can yield further contextual inferences that can be explored and validated in user interactions. The described mechanism not only illustrates the optional association of one Relationship Type 302 to another through a specific form of Relationship Type Property 307 and the optional link 312 but also opens the possibility for more complex data architecture implementations. Such implementations might allow for the association of more than two Relationship Types 302 through Relationship Type Properties, enabling a rich network of inferences and relationships within the system.

To enhance its capability for providing contextually relevant responses, the system 110 can use an expanded data architecture feature that incorporates Criteria-Value Rating Pair Values 313 into the selection process for user responses. These responses are stored within the Extended Data area 306 of the system 110. This approach enables the system 110 to store an array of potential responses for specific situations or user contexts identified by Knowledge Records (KR) 304, either through the logic of the EI Controller 103 or as chosen directly by the user. Through this feature, the EI Controller 103 assesses the emotional impact or relevance of specific contexts by calculating and selecting one of the optional responses associated with a KR 304. This selection process is guided by the Criteria-Value Rating Pair Values 313 attributed to each response within the Extended Data 306. This enhancement allows the system 110 to not only deliver responses that are contextually aligned but also ensures these responses resonate on an emotional level with the user, thereby enriching the conversational experience.

According to some examples of the present specification, the system 110 incorporates “Personality Traits” to refine its contextual inference and response mechanism, aligning interactions more closely with user personalities. This feature enables contextual ratings influenced by users' Value Profiles, consisting of personal Criteria-Value Rating Pair Values 313 such as “compassion” and “humility,” independent of specific knowledge. This application, known as the “Emotionality” Personality Trait, allows for personalized response scalability. Users with identical KR ratings can receive differentiated responses based on their unique Criteria-Value Rating Pair Values 313, tailoring interactions to individual emotional dispositions. Additionally, System 110 can use supervisory personality modeling to categorize Criteria Values 313 into Personality Traits like “Empathy,” “Ethical,” or “Outgoing.” This modeling involves assigning Criteria Values 313 to a named Personality Trait and rating it on a scale of 0 to 10. Variations from the neutral midpoint (5) either amplify or dampen the impact of associated Criteria Values during the net value calculation of rated KRs, adjusting response sensitivity to the user's emotional and ethical characteristics. By integrating these approaches, NLG responses in the system 110 are influenced both by available Criteria-Value Rating Pair Values 313 and the modulation of responses based on Personality Trait settings. This leads to nuanced responses that are dynamically adjusted for each user, enhancing the conversational experience. For example, a straightforward statement of being tired may receive a basic response, while a mention of personal loss triggers a more empathetic reply, demonstrating the capability of the system 110 to adapt its conversational tone and prioritization according to user personality and context.

According to examples of the present specification, system 110 incorporates the capability to tag Extended Data (text or links) with location information. This feature allows the system to tailor its Natural Language Generation or selection of responses by utilizing the user's geographic location. This location data can be acquired from various sources, including device information, internet service provider geolocation services, or directly from the user, through inputs such as postal codes or other geographic identifiers. By integrating this location feature, the system 110 is equipped to offer responses that are not only emotionally resonant but also geographically pertinent. This ensures that the information provided to the user is contextually relevant, enhancing the overall user experience by aligning responses with the user's immediate geographical context and emotional state.

According to examples of the present specification, the system 110 includes a number of enhancements, some of which are described in Table 2, designed to advance the field of conversational intelligence. These enhancements not only enrich the ability of the system 110 to interact with users in a nuanced and personalized manner but also expand its inferential capabilities, ensuring responses are relevant, emotionally attuned, and geographically appropriate.

TABLE 2
Selected Enhancements

Multiple States of Knowledge: Enables validation of issues with the user, accommodating nuanced
conversational intelligence by discerning true or false states.
Advanced Logic and Inference: Driven by Relationship Type properties and their optional associations
to other Relationship Types, facilitating complex reasoning (e.g., “has child” inversely linked to “has
parent”).
Term Categorization Through Knowledge Records: Enhances logic, inference, and Natural Language
Generation (NLG) by categorizing terms (e.g., “hello” as a member of “greetings”).
Knowledge Record to Term and to Knowledge Record Association: Supports logic encapsulation and
user interaction for validation, enhancing inference based on associations (e.g., “house - can be -
burned” to “house fire”).
Personalization Through Extended Data and Personality Traits: Utilizes Criteria-Value Rating Pairs and
Personality Traits to tailor responses and conversational tone, ensuring appropriateness for different
personalities.
Self-Learning Capabilities: From user conversations and external data sources, enriching the
Knowledgebase with new Triples and facilitating ongoing system evolution.
Location-Based Responses: Generates or selects responses based on user's geographical location,
adding a layer of contextual relevance.
Long-Term Conversation Graphs: Maintains memories of interactions, supporting a continuous and
evolving dialogue with users.
User Engagement for Knowledge Learning: Involves users in identifying new Knowledge Records and
Criteria-Value Ratings, supporting both supervised and unsupervised learning.
Large Language Model (LLM) Integration: Employs LLM for consistent responses aligned with a user's
language style, summarization of long inputs, and intelligent search for sourcing information beyond
the existing Knowledgebase.
Security and Interaction Enhancement: Incorporates a Registration Layer for secure access and
engages communities in creating or validating Extended Data.
Scheduled Delivery and Knowledge Graph Governance: Offers scheduled delivery of Extended Data
and employs a Knowledge Graph, guided by Rated Value pairs, to inform or oversee other Al
platforms.

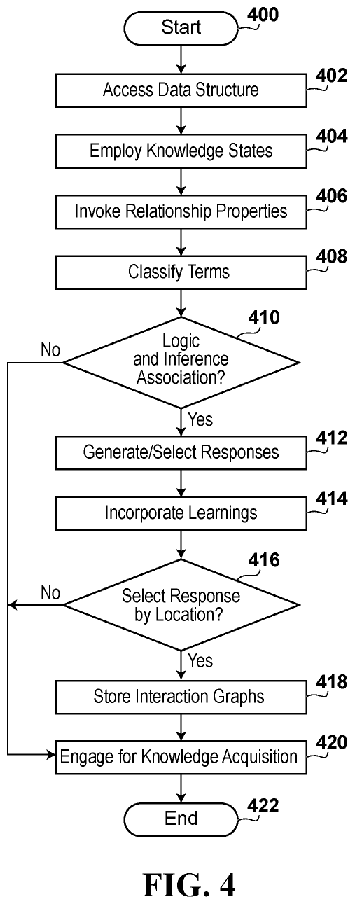

FIG. 4 outlines a method for natural language processing, according to one example of the present specification. The method starts at 400. At 402, the system 110 accesses a data structure containing Knowledge Records, Terms, and Relationship Types essential for initial contextual analysis. The method uses knowledge states 404 to support interactive nuances and invoking relationship properties at 406 for inference. Terms are then classified at 408 according to their associations in Knowledge Records, aiding response generation. At decision point 410, the system 110 assesses the possibility of associating logic and inference with the context, leading to response generation or selection 412 if affirmative. If not, the system 110 engages in knowledge acquisition 420 to gather information. At 414, the system 110 incorporates learnings from interactions and external sources into the data structure. The method includes evaluating whether to select responses based on location information at 416, storing interaction graphs at 418 for geographically relevant contexts, and revisiting knowledge acquisition at 420. The engagement for knowledge acquisition at 420 occurs continuously refine the Knowledgebase 101 of the system 110. The process concludes at 422.

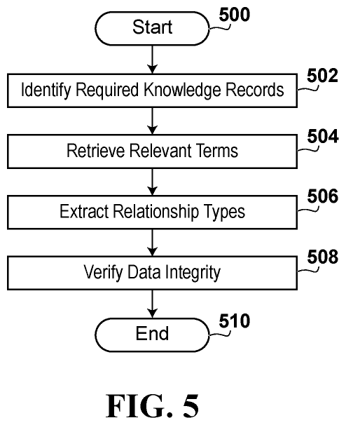

FIG. 5 outlines the “Access Data Structure” phase of natural language processing, in accordance with FIG. 4. Starting at 500, the system 110 identifies required Knowledge Records at 502. It then retrieves relevant terms at 504 and extracts Relationship Types at 506, used for interpreting how terms relate. To ensure reliability, the system verifies data integrity at 508 before concluding this phase at 510.

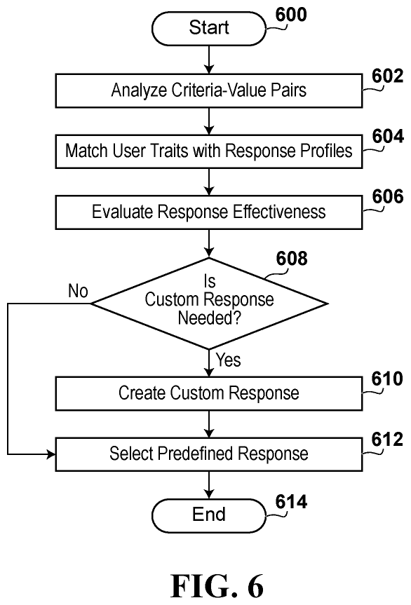

In FIG. 6, the “Generate/Select Responses” phase of natural language processing, in accordance with FIG. 4, begins at 600, where the system 110 starts with analyzing criteria-value pairs at 602 to interpret the context of user queries accurately. The system 110 then matches user traits with response profiles at 604, tailoring responses to individual user characteristics. Following this, the system evaluates response effectiveness at 606 to determine the suitability of potential responses. Faced with a decision at 608 on whether a custom response is necessary, the system either creates a custom response at 610 if required or selects a predefined response at 612 if not. This approach ensures that responses are not only contextually appropriate but also personalized, concluding the process at 614.

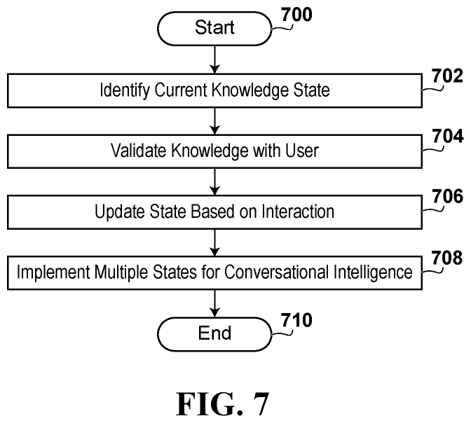

FIG. 7 illustrates the “Employ Knowledge States” segment of FIG. 4, beginning at 700. The process identifies the current knowledge state at 702, used for understanding the user's context and the system's data landscape. Following this, the system validates knowledge with the user at 704, ensuring accuracy and relevance. It then updates the state based on the interaction at 706, adapting to new information or corrections provided by the user. The system implements multiple states at 708, accommodating various stages of user interaction and understanding, concluding the process at 710.

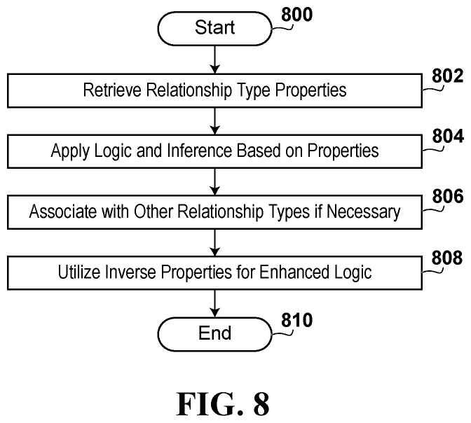

In FIG. 8, the “Invoke Relationship Properties” segment of FIG. 4 is outlined, starting at 800. Here, the system retrieves relationship type properties at 802, forming the basis for logical and inferential processing. It applies logic and inference based on these properties at 804, expanding the contextual understanding. If necessary, the system associates with other Relationship Types at 806, expanding the inferential scope. Using inverse properties at 808 enhances the logic further, the method ends at 810.

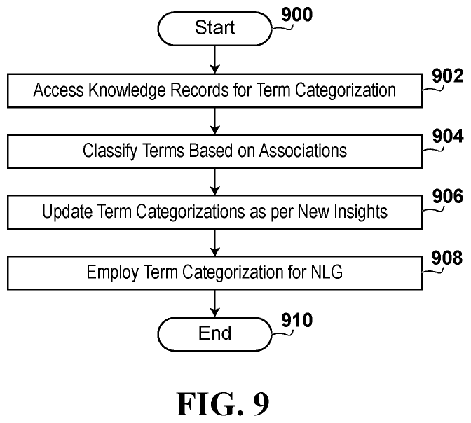

FIG. 9 illustrates the “Classify Terms through Knowledge Records” segment of FIG. 4, commencing at 900. The system accesses Knowledge Records for term categorization at 902, ensuring terms are accurately grouped for relevance. It classifies terms based on associations at 904, linking them to specific contexts or meanings. New insights lead to updated term categorizations at 906, keeping the system's understanding current. This classification aids in natural language generation (NLG) at 908, tailoring responses more precisely, concluding at 910.

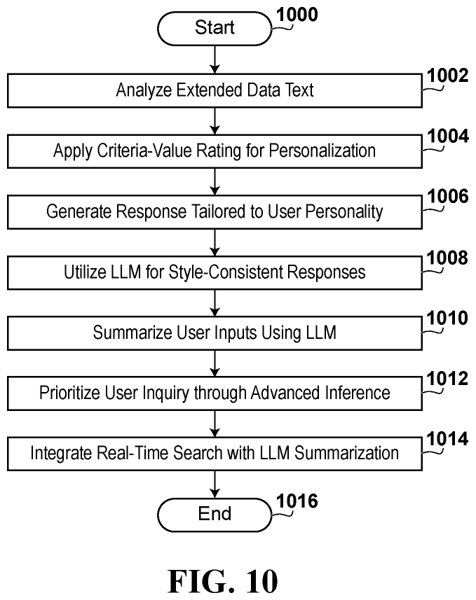

Lastly, FIG. 10 illustrates the “Generate/Select Responses based on Criteria-Value Rating” segment of FIG. 4, starting at 1000. The system analyzes extended data text at 1002, gathering context for personalized response generation. It applies criteria-value rating for personalization at 1004, aligning responses with user preferences. A response tailored to the user's personality is generated at 1006, while the Large Language Model (LLM) is used at 1008 for style-consistent responses. The LLM also summarizes user inputs at 1010, ensuring brevity and relevance. User inquiries are prioritized through advanced inference at 1012, and real-time search integrated with LLM summarization at 1014 enhances response accuracy and relevance, concluding the detailed process at 1016.

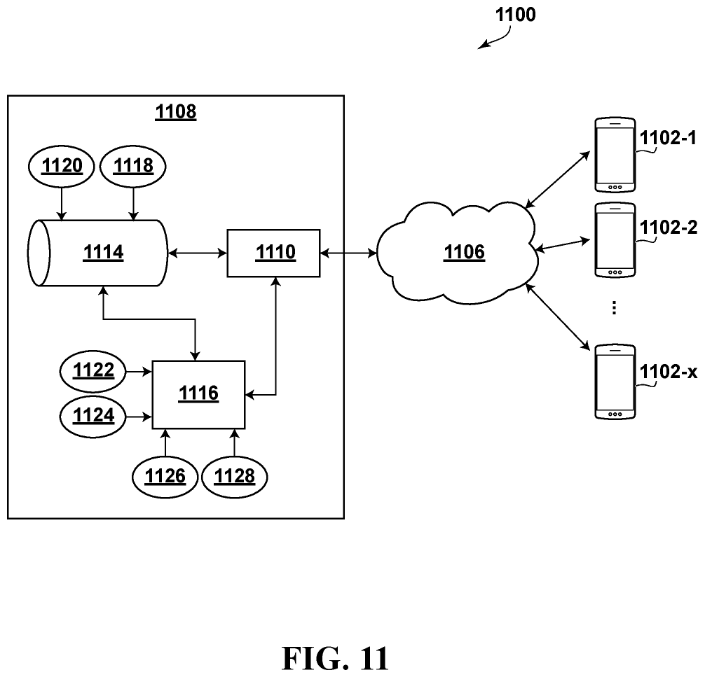

A block diagram of an example of a system 1100 for natural language processing is shown in FIG. 11. According to this example, the system 1100 includes one or more electronic devices 1102-1, 1102-2, . . . 1102-x (generically referred to herein as “electronic device 1102” and collectively as “electronic devices 1102”; this nomenclature will also be used for other elements herein), all of which are connected to a server 1108 via a network 1106.

The server 1108 is typically a server or mainframe within a housing containing an arrangement of one or more processors 1116, volatile memory 1114 (i.e., random access memory or RAM), persistent memory 1114 (e.g., hard disk devices), and a network interface device 1110 (to allow the server 1108 to communicate over the network 1106) all of which are interconnected by a bus. Many computing environments implementing the server 1108 or components thereof are within the scope of the invention. The server 1108 can include a pair of servers for redundancy, connected via the network 1106 (e.g., an intranet or across the Internet) (not shown).

The server 1108 can be connected to other computing infrastructure including displays, printers, data warehouse or file servers, and the like (not shown in FIG. 11). The server 1108 includes a network interface device 1110 interconnected with the processor 1116. The network interface device 1110 allows the server 1108 to communicate with other computing devices such as the electronic devices 1102 via a link with the network 1106, or via a direct, local connection (such as a Universal Serial Bus (USB) or Bluetooth™ connection, not shown). The network 1106 can include any suitable combination of wired and/or wireless networks, including but not limited to a Wide Area Network (WAN) such as the Internet, a Local Area Network (LAN), HSPA/EVDO/LTE cell phone networks, WiFi networks, and the like. The network interface device 1110 is selected for compatibility with the network 1106, as well as with local links as desired. In one example, the link between the network interface device 1110 and the network 1106 is a wired link, such as an Ethernet link. The network interface device 1110 thus includes the necessary hardware for communicating over such a link. In other examples, the link between the server 1108 and the network 1106 can be wireless, and the network interface device 1110 can include (in addition to, or instead of, any wired-link hardware) one or more transmitter/receiver assemblies, or radios, and associated circuitry. The server 1108 can include a keyboard, mouse, touch-sensitive display (or other input devices), a monitor (or display, such as a touch-sensitive display, or other output devices) (not shown in FIG. 11). The server 1108 stores, in the memory 1114, a plurality of computer readable instructions executable by the processor 1116. These instructions can include an operating system (“OS”) and a variety of applications. Among the applications in the memory 1114 is an application 1104 (also referred to herein as “application 1104”; not shown in FIG. 11). When the processor 1116 executes the instructions of application 1104, the processor 1116 is configured to perform various functions specified by the computer readable instructions of the application 1104, as will be discussed below in greater detail. The server 1108 can also store in the memory 1114, a Conversation Graph 1118, and a Knowledgebase 1120 (which may be the same as Knowledgebase 101) as discussed above in greater detail. The memory 1114 can also store transmissions including input messages and response messages between one or more of the electronic devices 1102 and the server 1108.

Typically, the electronic devices 1102 are associated with users who provide natural language input for response from the server 1108. The electronic device 1102 can be any of a desktop computer, smart phone, laptop computer, tablet computer, smart speaker, automotive infotainment system, robot, and the like. The electronic device 1102 can include one or more processors, a memory, input and output devices (typically including a display, a speaker, a microphone, and a camera), and a network interface device as described above in connection with the server 1108 (not shown in FIG. 11). An electronic device 1102 can be operated by a user. The electronic device 1102 exchanges messages with the server 1108, via the network 1106 using a client application 1112 (not shown in FIG. 11) loaded on the electronic device 1102. In one example, the client application 1112 can be a web browser or native application that uses a web-based or mobile interface and exchanges messages including natural language input for response. According to some examples, the client application 1112 can receive spoken natural language input captured by the microphone of the electronic device 1102 and converted to text input by the electronic device 1102 or, in some cases, the server 1108. The spoken natural language input can be processed using known voice-to-text technology. In one alternative example, the electronic device 1104 can be a crawling engine (not shown in FIG. 11). A crawling engine is a server or application that provides functionality for automated “bot” or web crawling of data sources, in the case of the Internet or a database query processor in the case of an intranet, or an enterprise or institutional database system. According to this example, the crawling engine provides natural language input from crawled web pages, text or other media assets located in such enterprise or institutional databases, intranets or on the Internet. The crawling engine may identify problems and identify and “learn” new Terms, Relationship Types, and Evaluation Criteria-Rating pairs, as those terms are discussed below.

As mentioned above, the memory 1114 maintains a conversation graph 1118 and a Knowledgebase 1120 (also known as Knowledgebase 101). The Knowledgebase 1120 can be a database application loaded on the server 1108, a stand-alone database server, or a virtual machine in communication with the network interface device 1110 of the server 1108, or any other suitable database.

The memory 1114 maintains one or more conversation graphs 1118-1, 1118-2, . . . , 1118-m. The conversation graph 1118 includes a plurality of nodes and a plurality of links. Each node is associated with a term. The term corresponds to an object (e.g., “apple”, “seed”) or to a concept (e.g., “hunger”). Two nodes can be connected by one or more links. A link can be associated with one or more Relationship Types and one or more evaluation criteria-rating pairs. The relationship type corresponds to a “type” of relation between two terms (e.g., “possession”, “contains”, “exhibits”).

Two nodes can be linked where a relationship is detected (e.g., an “apple” “contains” “seed(s)”). The evaluation criteria-rating pair value refers to an evaluation criteria label and an associated rating value (e.g., < “taste”, +5>, < “nutrition”, +4>).

The Knowledgebase 1120 maintains one or more electronic records for populating the Conversation Graphs 1118, as discussed below. Typically, the Knowledgebase 1120 includes a table of text strings that indexes or associates a given text string with Terms 1136 or Relationship Types 1140.

Furthermore, the Knowledgebase 1120 includes a table of known Evaluation Criteria-Rating Pair Values 1140 corresponding to two Terms 1136 and one Relationship Type 1140 (also referred to as term pairs). Two terms 1136 can be associated with multiple Relationship Types 1140 and each Relationship Type 1140 can be associated with multiple Evaluation Criteria-Pair Values 1140.

Still with reference to FIG. 11, the system 1100 further includes a parsing routine 1122, a graph population routine 1124, a graph traversal routine 1126, and an evaluation routine 1128. In one example, the system 1100 can include a crawling routine 1129. These routines are sometimes referred to as modules or engines. Typically, each of the routines comprises instructions, for example by way of application 1104, to determine the functioning of the processor 1116 of the server 1108. In other examples, however, some of or all the routines may be part of other applications, servers, or other computing infrastructure. In this case, the method steps may communicate with components of the server 1108 including the Conversation Graph 1118 or the Knowledgebase 1120 via the network interface device 1110.

One general aspect includes a method for contextual inference and response generation in natural language. A data structure containing Knowledge Records, Terms, and Relationship Types is accessed to facilitate interaction, inference and further interaction to validate knowledge states and employs Relationship properties for inference, classifying terms to generate responses. Logic and inference mechanism link Knowledge Records and Terms for response generation. Responses are tailored based on Criteria-Value Rating Pairs and user Personality Traits, with the system adapting through learnings from user interactions and external data. The method includes storing interaction graphs. Additionally, the system features modules for natural language understanding, interaction, response generation, and user engagement, all executed on a processing unit. The system dynamically updates its Knowledgebase and refine response mechanisms, offering personalized and contextually relevant interactions in natural language. This method is executed by a processing unit within a computer system.

Implementations may include one or more of the following features: using a Large Language Model (LLM) to enhance the generation or selection of responses, where the LLM leverages past conversations or written examples from the user for consistent response generation; classifying terms through Knowledge Records includes categorizing greetings and languages to support culturally and linguistically appropriate response generation; using real-time intelligent search to augment the data structure when existing Knowledge Records do not suffice for generating appropriate responses, with the search extending across internet or intranet data sources; generating or selecting responses based on Criteria-Value Rating Pairs involves adjusting response selection according to the emotional impact denoted by these pairs; adjusting conversational tone based on identified user personality traits, such as empathy or ethical considerations, to ensure responses are tailored to the user's emotional state; storing interaction graphs for the long-term retention of conversational contexts, facilitating seamless resumption and contextualization of interactions with users; securing access and interaction with the data structure to protect the privacy and integrity of user-contributed data; refining algorithmic parameters within the data structure to enhance the system's accuracy and responsiveness over time, informed by feedback loops from user interactions; adjusting responses based on the time of day or day of the week for temporal relevance, selecting responses that align with the user's likely activities at specific times; dynamically generating personalized prompts or questions based on identified gaps in the Knowledge Records to address user needs more effectively; analyzing sentiment of user inputs to tailor responses, employing sentiment analysis to ascertain the user's emotional state for generating empathetically aligned responses; introducing a mechanism for the automatic update and expansion of Knowledge Records in response to emerging trends and vocabularies identified from broader internet or intranet sources; selecting responses based on the analysis of user interaction history to anticipate user needs or questions before they are explicitly stated; using user feedback on responses to continually refine and improve response accuracy and relevance, ensuring that the system evolves in line with user expectations and needs. A further feature includes providing contextual and ontological information, including Criteria-Value Rating Pairs, to third-party systems via an API. It involves structuring Knowledge Records, Terms, and Relationship Types for third-party integration, transmitting these to these third-party systems such as LLMs, responding to their informational requests, and supplying enriched data to facilitate personalized, context-relevant responses.

While the invention has been described with reference to the specific embodiments, it will be understood by those skilled in the art that various changes may be made without departing from the scope of the present specification. Furthermore, the scope of the present specification is not intended to be limited to the specific embodiments described herein. Additionally, the range of embodiments described herein is not intended to limit the scope of the present specification. Rather, the invention encompasses all modifications and variations within the scope of the present specification.

1. A method for contextual inference and response generation in natural language, the method comprising:
accessing a data structure, comprising a plurality of Knowledge Records, Terms, and Relationship Types;
using states of knowledge to facilitate interaction;
invoking relationship type properties for inference;
classifying Terms through Knowledge Records for response generation;
associating logic and inference through Knowledge Record to Term and Knowledge Record to Knowledge Record linkages;
generating or selecting responses based on Criteria-Value Rating Pairs and user Traits;
incorporating learnings comprising insights, adjustments to algorithmic parameters, and constructed models that result from the processing, analysis, and interpretation of user interactions and external data sources, into the data structure;
selecting responses based on location information; and
storing interaction graphs;
wherein the method is performed by a processing unit of a computer system.

2. The method of claim 1, further comprising using a Large Language Model (LLM) to enhance the generation or selection of responses, wherein the LLM uses past conversations or written examples from the user as input for response consistency.

3. The method of claim 1, wherein classifying terms through Knowledge Records comprises categorizing greetings and languages to support culturally and linguistically appropriate response generation.

4. The method of claim 1, further comprising using real-time intelligent search to complement the data structure when existing Knowledge Records are insufficient for generating appropriate responses, wherein the search is conducted across internet or intranet data sources.

5. The method of claim 1, wherein generating or selecting responses based on Criteria-Value Rating Pairs involves adjusting response selection based on the emotional impact indicated by the Criteria-Value Rating Pairs.

6. The method of claim 5, wherein the Criteria-Value Rating Pairs are further used to adjust conversational tone based on identified user personality traits, such as empathy or ethical considerations.

7. The method of claim 1, wherein storing interaction graphs includes the long-term retention of conversational contexts to facilitate the resumption of interactions with users at future points.

8. The method of claim 1, further comprising securing access and interaction with the data structure, safeguarding the privacy and integrity of user-contributed data.

9. The method of claim 1, wherein incorporating learnings into the data structure comprises refining algorithmic parameters to enhance the system's accuracy and responsiveness over time based on feedback loops from user interactions.

10. The method of claim 1, further comprising adjusting responses based on the time of day or day of the week to ensure temporal relevance, wherein responses are selected to align with the user's likely activities at specific times.

11. The method of claim 1, comprising dynamically generating personalized prompts or questions based on gaps identified in the Knowledge Records.

12. The method of claim 1, further comprising analyzing sentiment of user inputs to tailor responses, where the sentiment analysis helps to determine the emotional state of the user for generating empathetically aligned responses.

13. The method of claim 1, further comprising a mechanism for automatic update and expansion of the Knowledge Records based on emerging trends and vocabularies identified from the broader internet or intranet sources.

14. The method of claim 1, wherein responses are selected based on the analysis of user interaction history to predict user needs or questions before they are explicitly stated.

15. The method of claim 1, further comprising employing user feedback on responses to refine and improve response accuracy and relevance.

16. The method of claim 1, further comprising providing contextual and ontological information, comprising Criteria-Value Rating Pairs, to third-party systems through an API interface, wherein the method includes:
formatting the accessed Knowledge Records, Terms, Relationship Types and Criteria-Value Rating Pairs into structured data payloads suitable for third-party integration;
transmitting these data payloads to third-party systems comprising Large Language Models (LLMs);
receiving requests from the third-party systems for specific information based on the third-party system's current contextual analysis and user interaction needs;
selecting and sending enriched Knowledge Records and associated Criteria-Value Rating Pairs in response to the requests, aiding the third-party systems in generating contextually relevant and personalized responses.

17. A system for contextual inference and response generation in natural language, comprising:
a memory storing instructions; and a processor configured to execute the instructions to:
access a data structure, comprising a plurality of Knowledge Records, terms, and Relationship Types;
use states of knowledge to facilitate interaction;
invoke relationship type properties for inference;
classify terms through Knowledge Records for response generation;
associate logic and inference through knowledge record to term and knowledge record to Knowledge Record linkages;
generate or selecting responses based on Criteria-Value Rating Pairs and user Traits;
incorporate learnings comprising insights, adjustments to algorithmic parameters, and constructed models that result from the processing, analysis, and interpretation of user interactions and external data sources, into the data structure;
selecting responses based on location information; and
store interaction graphs.

18. At least one non-transitory computer-readable storage medium storing instructions that, when executed by at least one processor, cause the at least one processor to:
access a data structure, including a plurality of Knowledge Records, terms, and Relationship Types;
use states of knowledge to facilitate interaction;
invoke relationship type properties for inference;
classify terms through Knowledge Records for response generation;
associate logic and inference through knowledge record to term and knowledge record to knowledge record linkages;
generate or select responses based on Criteria-Value Rating Pairs and user traits;
incorporate learnings comprising insights, adjustments to algorithmic parameters, and constructed models that result from the processing, analysis, and interpretation of user interactions and external data sources, into the data structure;
select responses based on location information; and
store interaction graphs.
